(19) United States
(12) Patent Application Publication
(10) Pub. No.: US 2021/0086590 A1
(43) Pub. Date: Mar. 25, 2021

(54) OUTFLOW NOZZLE OF A MOTOR VEHICLE

(71) Applicant: NOVARES LÖHNE GMBH, Löhne (DE)

(72) Inventors: Viktor SCHMIDT, Bad Oeynhausen (DE); Peter HAMKE, Löhne (DE); Eva POHLMANN, Löhne (DE)

(21) Appl. No.: 16/633,799

(22) PCT Filed: Jul. 19, 2018
(86) PCT No.: PCT/EP2018/069637

§ 371 Date: Jan. 24, 2020

(30) Foreign Application Priority Data
Jul. 24, 2017 (DE) 10 2017 116 696.3

(51) Int. Cl. B60H 1/34; B60H 1/24

(52) U.S. Cl. CPC B60H 1/3428; B60H 1/345; B60H 1/34; B60H 1/24

(57) ABSTRACT

An outflow nozzle of a motor vehicle includes a housing having at least one outflow slit on the outflow side. The housing narrows towards the outflow slit while forming guide surfaces, in which housing a horizontal lamella that is assigned to the outflow slit and that can be changed in its position is mounted. On the outer side, the horizontal lamella is provided with opposing lead surfaces for the air flow. Transversely to the horizontal lamella, at least one vertical lamella that is pivotable about a vertical pivot pin is arranged. The lead surfaces of the horizontal lamella, which can be pivoted about a horizontal pivot axis, run in an inclined manner towards the outflow slit.

### BACKGROUND AND SUMMARY OF THE INVENTION

Exemplary embodiments of the invention relate to an outflow nozzle of a motor vehicle.

Outflow nozzles are mainly used to supply fresh air or heated air to the interior of a motor vehicle. In particular for changing the direction of flow of the air exiting the outflow nozzle, it is known, for example, from DE 10 2005 027 746 A1, to allocate a horizontal lamella to several outflow slits arranged parallel to and at a distance from one another, which are part of a lamella grating and which comprise lead surfaces inclined in a wedge or convex shape in the opposite direction to the direction of flow, which are in correspondence with guide surfaces extending in an inclined manner to one another in the direction of flow, which delimit the outflow slit.

When the horizontal lamella are adjusted, there is a corresponding change in direction of the air exiting horizontally from the outflow slits.

In order to be able to influence the outgoing air also in a transverse direction, i.e., in a vertical plane, vertical lamella are arranged behind the horizontal lamella, in relation to the outflow slits, which can be pivoted independently of the horizontal lamella.

However, it has been shown that precisely this vertical deflection is not possible to the desired extent, which is due in particular to the fact that the horizontal lamella cannot be pivoted, but can only be moved linearly in both vertical and horizontal directions towards the outflow slits until they are closed.

Due to the resulting turbulence, the outflowing air is not guided without obstruction, so that the flow efficiency does not meet the requirements.

In addition to the functional disadvantages of the known outflow nozzle mentioned above, its possible use is also clearly limited. There are increasing demands to create an outflow nozzle with only one outflow slit, which is especially due to design aspects.

The known outflow nozzle is not suitable for this purpose, in particular due to the conceptual design, which would have to be changed completely without thereby correcting the described functional deficiencies.

Exemplary embodiments of the invention are directed to an outflow nozzle with improved function and usability.

As has been recognized surprisingly, the design of the horizontal lamella according to the invention, in which the lead surfaces are extend in an inclined manner towards the outflow slit, enables an unhindered, directed air flow, namely in any position of the horizontal lamella as well as the vertical lamella.

This optimized air flow is supported in that, according to the state of the art, the horizontal lamella is wedge-shaped in cross-section against the direction of flow.

According to the invention, an edge obstructing the air flow, which would lead to turbulent swirling, is no longer present in the horizontal lamella according to the invention.

According to a further aspect of the invention, the lead surfaces of the horizontal lamella, which are swept by the flow air, and the respective associated guide surfaces of the housing extend approximately parallel to each other at least in the upwardly or downwardly pivoted position of the horizontal lamella. Even in a symmetrical orientation of the horizontal lamella in relation to the outflow slit, the guide and guiding surfaces are aligned approximately parallel.

In contrast to the prior art, according to which the horizontal lamella is only linearly adjustable, the horizontal lamella, according to a further aspect of the invention, is pivotable about a horizontal pivot axis, wherein stops are provided on at least one side wall of the housing for limiting the pivoting, against which a pivot bracket carrying the horizontal lamella rests in the pivoted end position.

The at least one, but usually several vertical lamella arranged parallel and at a distance from each other, which guide the air flow to the right or left to the air outflow slit, are pivotably held by means of a coupling element on the horizontal lamella, preferably on the opposite pivot brackets which are pivotably connected to the housing walls.

Thus, the arrangement of the vertical lamellas essentially follows the pivot path of the horizontal lamella when it is pivoted, which leads to the above-mentioned unobstructed outflow of air in this direction as well.

The simultaneous and unidirectional pivoting of the vertical lamellas, for which purpose they are each mounted on the coupling element or a coupling rod of the coupling element by means of a pivot pin, is carried out by means of a lamella comb acting on all vertical lamellas and held so that it can be moved in the longitudinal axis direction.

Both the pivoting movement of the horizontal lamella and the joint pivoting of the vertical lamellas transversely to it can be carried out manually by means of an operating wheel or by motor.

A suitable brake can be provided to prevent the horizontal lamella from rotating, for example a silicone brake in operative connection with the horizontal lamella, i.e., its pivot brackets, as well as with the wall of the housing.

In addition, the air flow can be throttled or interrupted by a throttling device, such as a flap, provided at the air inlet to the housing.

### BRIEF DESCRIPTION OF THE DRAWINGS

An embodiment example of the invention is described below using the attached drawings, wherein:

FIG. 1 shows an exploded view of a nozzle according to the invention;

FIG. 2 shows the rear view of the outflow nozzle;

FIGS. 3a)-3c) show different functional positions of the outflow nozzle, corresponding to the intersection line A-A in FIG. 2;

FIGS. 4a)-4c) show different functional positions of the outflow nozzle, in a schematic sectional side view according to line B-B in FIG. 2;

FIGS. 5a)-5c) show different functional positions of the outflow nozzle in a schematic sectional side view according to line C-C in FIG. 2;

FIGS. 6a)-6c) different functional positions of the outflow nozzle, each in a sectional side view according to the line D-D in FIG. 2;

FIGS. 7 and 8 each show a detail of the outflow nozzle in perspective view;

FIG. 9 shows a cross-section of another detail of the outflow nozzle after the invention.

### DETAILED DESCRIPTION

It should be noted at first that the terms horizontal, vertical, top and bottom refer to the position of an outflow nozzle installed in a motor vehicle.

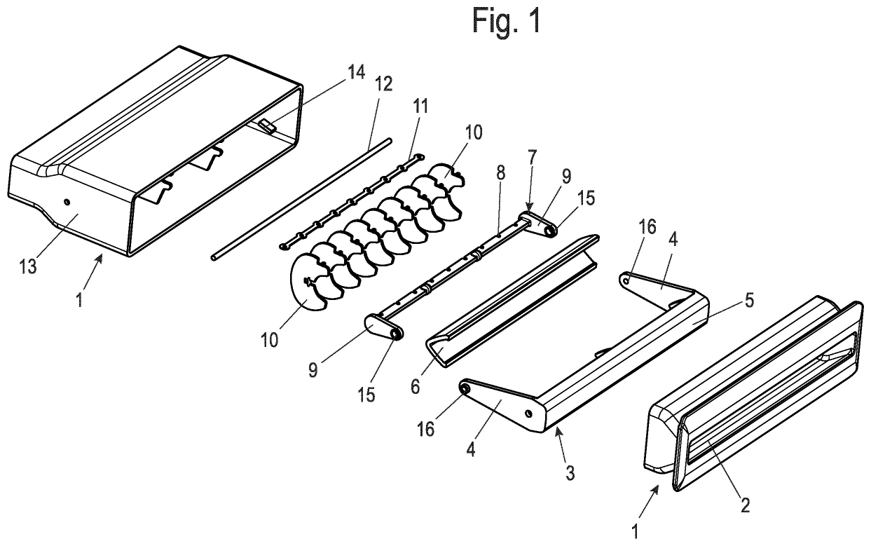

FIG. 1 shows an exploded view of an outflow nozzle according to the invention for a motor vehicle, having a two-part housing 1, which is designed as an orifice with an outflow slit 2 on the outflow side.

On the opposite side, housing 1 is connected to an air supply (not shown).

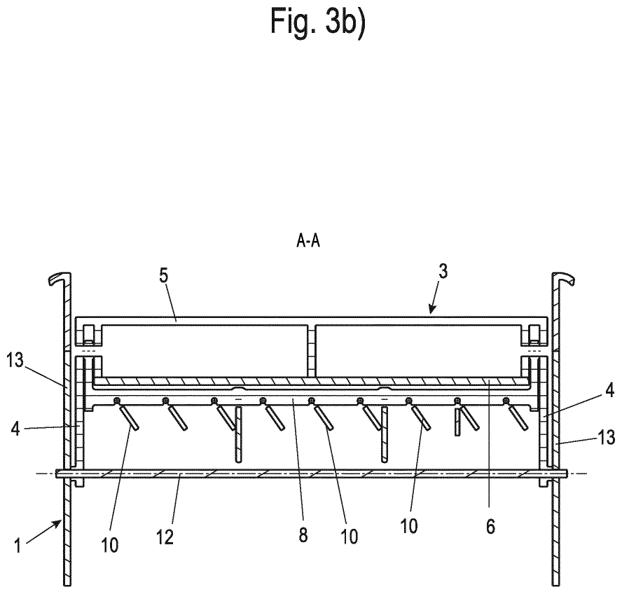

As can be seen, for example, in FIGS. 4a)-4c), the housing 1 is formed in the area of the outflow slit 2 towards, in the outflow direction marked by arrows, two mutually opposite guide surfaces 17 inclined towards the outflow slit 2, resulting in a directional effect.

A horizontal lamella 3 is assigned to the outflow slit 2, the horizontal lamella 3 consisting of a lamella bar 5 and a lamella cap 6 connected to it, wherein in the example the horizontal lamella 3 is mirror-symmetrical in cross-section in the direction of flow.

At each of the opposing end faces of the lamella bar 5, a pivot bracket 4 is connected, which has axle bearings 16 at its free end, which serve to accommodate a pivot axis 12, by means of which the horizontal lamella 3 is pivotably mounted on side walls 13 of housing 1.

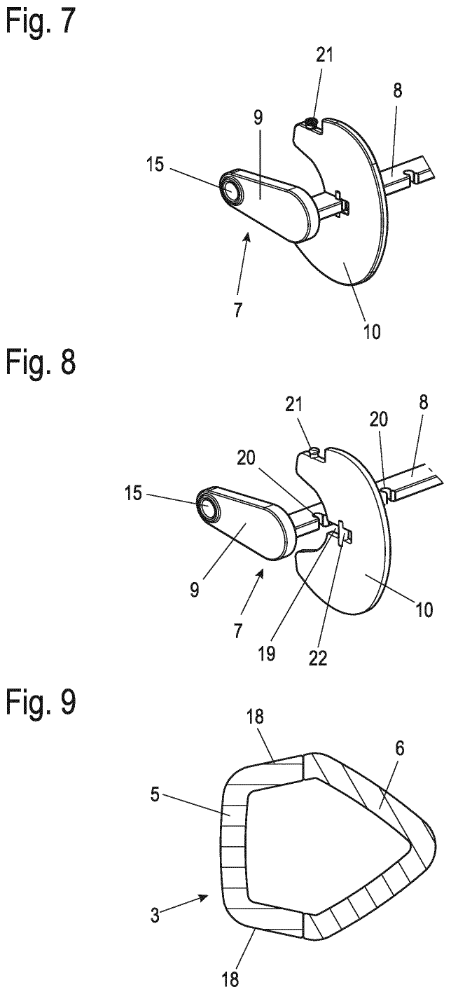

As shown in particular in FIGS. 4a)-4c), and also in FIG. 9, which shows a horizontal lamella 3 in cross-section, lead surfaces 18 of the horizontal lamella 3 are formed to extend in an inclined manner towards the outflow slit 2, preferably in such a way that they extend approximately parallel to the guide surfaces 17. This ensures that the flowing air is guided to the outflow slit 2 without obstruction.

While the lead surfaces 18 are provided on the lamella bar 5, the lamella cap 6 is wedge-shaped in cross-section against the direction of flow, with all the edges formed being rounded to avoid flow resistance and noise-generating turbulence.

FIG. 4a) shows a schematic section of the horizontal lamella 3 in a downwardly pivoted position, so that the air flow is guided above the horizontal lamella 3. Especially in this position the parallelism of the guide surface 17 and the guide surface 18 is clearly visible.

Coupling brackets 9 are pivotably connected to the pivot brackets 4 by means of pivot pins 15, which are also part of a coupling element 7 as well as a coupling rod 8 to which the coupling brackets 9 are attached.

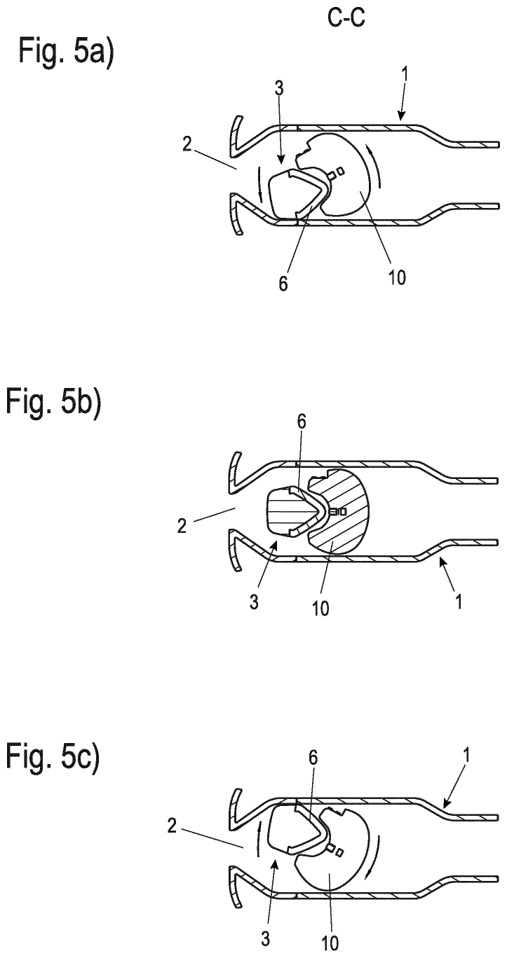

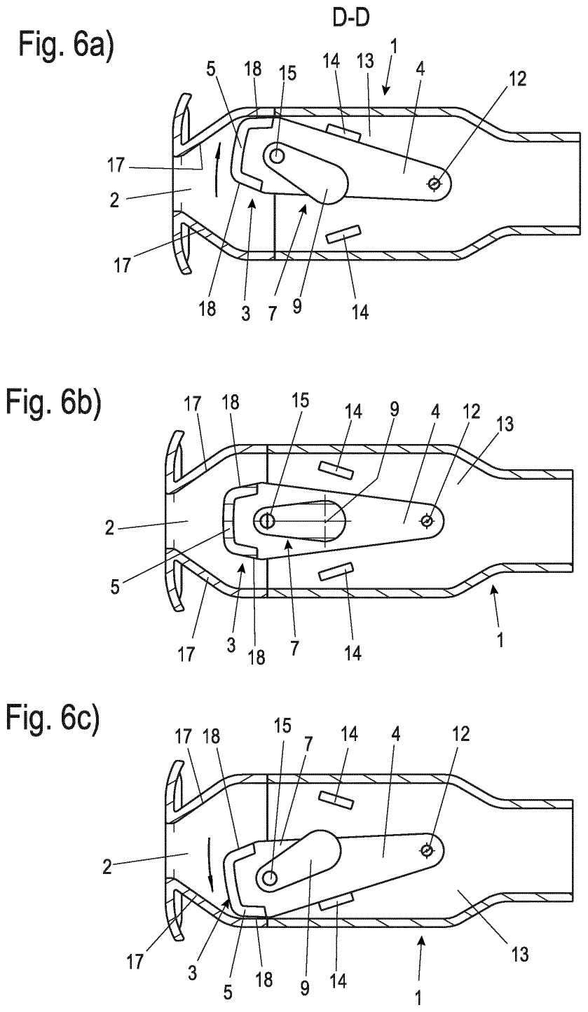

On this coupling rod 8, several vertical lamellas 10 are pivotably held parallel and spaced apart from each other, preferably at the same distance, in the longitudinal direction of the coupling rod 8. For this purpose, each vertical lamella 10 has a pivot pin 22 that engages in a bearing opening 20 of the coupling rod 8, wherein a slit 19 in the vertical lamella 10 enables the pivot pin 22 to be inserted into the bearing opening 20. This is particularly evident in FIGS. 7 and 8.

For pivoting the vertical lamella 10, a rod-shaped lamella comb 11 is provided, having bearing bores in which rotary pins 21 of the vertical lamella 10 engage, so that a pivoting movement of all vertical lamella 10 results when the lamella comb 11 is moved axially.

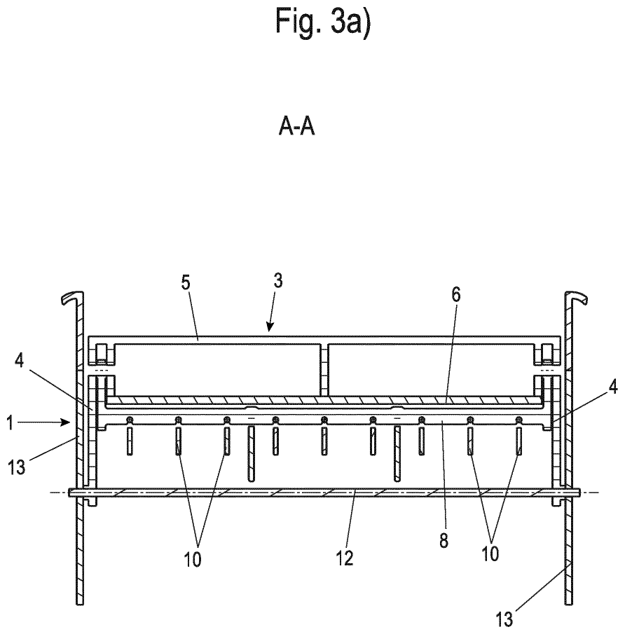

In FIG. 3a), the vertical lamellas 10 are aligned parallel to the side walls 13 of the housing 1 and at a right angle to the coupling rod 8, whereas FIGS. 3b) and 3c) show the vertical lamella 10 pivoted to the right or left, so that they are at an angle to the coupling rod 8 and the outflowing air is directed out of the outflow slit 2.

FIG. 4a) shows a position of the horizontal lamella 3 in which the air is guided above and inclined downwards out of the outflow slit 2.

In FIG. 4b) a central, i.e., symmetrical position of the horizontal lamella 3 in relation to the outflow slit 2 can be seen, so that the air comes straight out of the outflow slit 2, whereas in FIG. 4c) the horizontal lamella 3 is pivoted upwards and the flowing air is directed upwards out of the outflow slit 2.

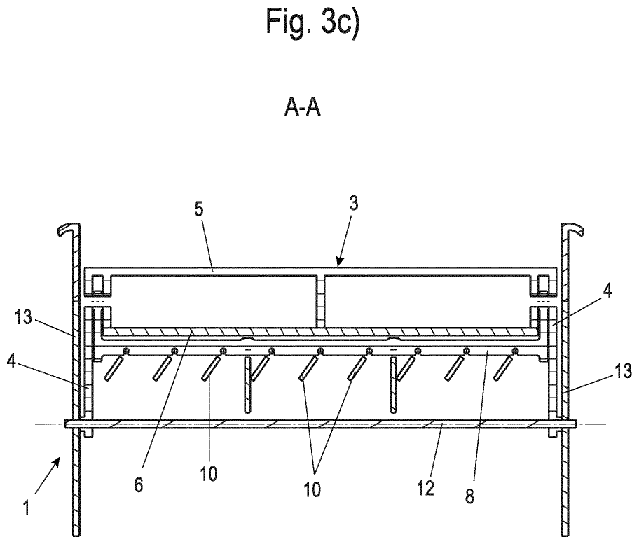

FIGS. 5a) to 5c) show the position of vertical lamella 10 in each of the comparable positions of horizontal lamella 3, which are pivoted with the horizontal lamella 3, since, as already mentioned, the coupling element 7 supporting the vertical lamellas 10 is hinged to the pivot brackets 4 of horizontal lamella 3 and thus also performs the pivoting movement of the latter. The pivoting movement is indicated by arrows in FIGS. 5a) to 5c).

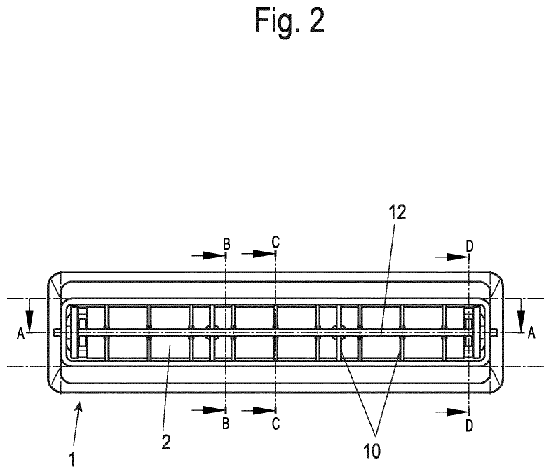

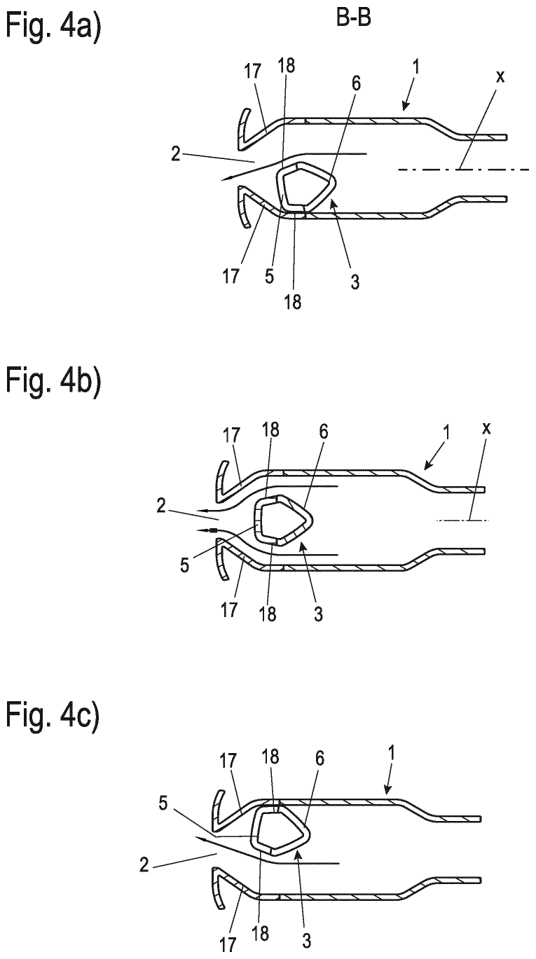

FIGS. 6a)-6c) show a position of horizontal lamella 3 identical to FIGS. 4a)-4c) and 5a)-5c). However, the illustrations in FIGS. 6a)-6c) show a section through the outflow nozzle according to line D-D in FIG. 2, thus showing the connection of the horizontal lamella 3 to the housing 1 or the side walls 13, as well as the coupling element 7 to the pivot bracket 4.

Furthermore, the arrangement of the stops 14 on the associated side wall 13 is particularly clear.

FIGS. 7 and 8 each show a section of the coupling element 7 with a vertical lamella 10, while FIG. 9 shows a cross-section of the horizontal lamella 3, which is designed as a hollow body and, as mentioned, consists of the lamella bar 5 assigned to the outflow slit 2 and the lamella cap 6 which is attached to it and is formed in a wedge-shaped manner in the opposite direction to the outflow slit 2.

As described, the invention is used for an outflow nozzle with only one outflow slit 2. However, it is also conceivable to implement the invention in the case of an outflow nozzle which, in accordance with the prior art, has several outflow slits 2 arranged parallel to and at a distance from one another, to each of which a horizontal lamella 3 and vertical lamella 10 are assigned.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE NUMERALS

1 Housing

2 Outflow slit

3 Horizontal lamella

4 Pivot bracket

5 Lamella bar

6 Lamella cap

7 Coupling element

8 Coupling rod

9 Coupling bracket

10 Vertical lamella

11 Lamella comb

12 Pivot axis

13 Side wall

14 Stop

15 Pivot pin

16 Axle bearing

17 Guide surface

18 Lead surface

19 Slit

20 Bearing opening

21 Rotary pin

22 Pivot pin

1-12. (canceled)

13. An outflow nozzle of a motor vehicle, the outflow nozzle comprising:
a housing having at least one outflow slit on an outflow side of the outflow nozzle and having guide surfaces that are inclined so as to narrow along the housing towards the outflow slit;
a horizontal lamella mounted in the housing in a manner such that the horizontal lamella are pivotable about a horizontal pivot axis, wherein an outer surface of the horizontal lamella has opposing lead surfaces for air flow; and
at least one vertical lamella is arranged in the housing transversely to the horizontal lamella, wherein the at least one vertical lamella is pivotable about a vertical pivot pin,
wherein the opposing lead surfaces of the horizontal lamella extend in an inclined manner towards one another in a direction towards the outflow slit.

14. The outflow nozzle of claim 13, wherein the at least one vertical lamella is pivotably secured on the horizontal lamella.

15. The outflow nozzle of claim 13, wherein the at least one vertical lamella is secured on the horizontal lamella by a coupling.

16. The outflow nozzle of claim 13, wherein the at least one vertical lamella comprises a plurality of vertical lamellas, wherein the plurality of vertical lamellas are connected to one another by an axially displaceable lamella comb.

17. The outflow nozzle of claim 13, wherein the horizontal lamella is wedge-shaped in cross-section on a side of the horizontal lamella facing away from the outflow slit.

18. The outflow nozzle of claim 15, wherein the horizontal lamella has two pivot brackets opposite each other, wherein the two pivot brackets are pivotably mounted on side walls of the housing by a pivot axis.

19. The outflow nozzle of claim 18, further comprising:
stops configured to limit a pivot angle of the two pivot brackets are arranged on mutually facing inner sides of the side walls of the housing.

20. The outflow nozzle of claim 13, wherein the inclination of the opposing lead surfaces of the horizontal lamella corresponds approximately to the inclination of the guide surfaces of the housing.

21. The outflow nozzle of claim 13, wherein the guide surfaces of the housing each extend at an angle of 30 to 40 degrees to horizontal.

22. The outflow nozzle of claim 18, further comprising:
coupling brackets attached at ends to a coupling rod of the coupling, wherein the coupling brackets are pivotably attached to the two pivot brackets.

23. The outflow nozzle of claim 22, wherein the at least one vertical lamella has a pivot pin rotatably secured in a bearing opening of the coupling rod, wherein the pivot pin is configured to pivot the at least one vertical lamella.

24. The outflow nozzle of claim 13, wherein the horizontal lamella has a lamella bar having the opposing lead surfaces and a lamella cap attached to the opposing lead surfaces on a side facing away from the outflow slit.
